(19) United States
(12) Patent Application Publication
(10) Pub. No.: US 2002/0171284 A1
(43) Pub. Date: Nov. 21, 2002

(54) Seatbelt shoulder pad

(76) Inventors: Geza Telekesi, Toronto (CA); Laszlo Telekesi, Toronto (CA)

Correspondence Address: Geza Telekesi, 102-149 St George St., Toronto, ON, M5R 2L9, CA

(21) Appl. No.: 09/858,449

(22) Filed: May 17, 2001

(51) Int. Cl. B60R 22/00

(52) U.S. Cl. 297/482

(57) ABSTRACT

A shoulder pad for use with a safety seatbelt having flexible and resilient walls. Said walls provide an opening to facilitate the seatbelt, when the shoulder pad is in free state. Said shoulder pad also has two projections, which are mated to interlock each other when said opening is closed.

### SUMMARY

For use with a safety seatbelt, when a part of the seatbelt causes discomfort for its user by coming into contact with sensitive parts of his or her body, a shoulder pad being placed between said safety seatbelt and its user. Said shoulder pad has walls mated to wrap around said safety seatbelt along a predetermined length.

### SPECIFICATION

It is known that when traveling in a vehicle such as a passenger car, it is eigther recommended or required by law to use safety seatbelt in the well-known manner. When in use, some parts of the safety seatbelt often rub against the user's body, for example the skin of the neck, if the user moves. This rubbing causes discomfort for the user. While the design of some of the safety seatbelts provide adjustability for the user, it is limited only to the placement of said safety seatbelt on the user's body but does not eliminate said rubbing.

Providing a shoulder pad for the user solves the above-mentioned problem. Various shoulder pads are already available on the market. However, these are constructed of multiple parts of multiple materials being put together by a labor consuming process such as sawing. Also, the installation of these shoulder pads on the seatbelt requires a lengthy procedure, since they have to be unfolded first, then wrapped around the seatbelt, and finally secured against opening.

The objects of this invention include providing a shoulder pad for use with a seatbelt which is:

simple in construction,

easy and cheap to manufacture, and

fast to install.

This invention provides a shoulder pad to prevent a predetermined length of a safety seatbelt to come into direct contact with its user, said shoulder pad has a bottom wall mated to cover one of the flat sides of said safety seatbelt, a first side wall joined to and protruding upward from said bottom wall at one end, a second side wall joined to and protruding upward from said bottom wall at its other end, and a top wall joined to said second side wall and extending toward said first side wall and diverging upward to provide an opening above said first side wall, said opening is larger than the thickness of said seatbelt, said first side wall has a first projection above and over the bottom wall, said top wall has a second projection at its end mated to said first projection, wherein a light pressure of bottom wall and top wall toward each other causes said opening to close and said first projection and said second projection to lock into each other.

This invention further provides a method to install a shoulder pad on a safety seatbelt, comprising:

providing a shoulder pad of the desired length and made of a softer material than that of said safety seatbelt, said shoulder pad has flexible and resilient walls mated to wrap around said seatbelt, said shoulder pad is split along its length and has a slightly opened V-shape in cross section when being in free state, said split is wider than the thickness of said seatbelt, said shoulder pad also has two projections mated to lock into each other, one projection is placed along one side of said split, the other projection is placed along the opposite side of said split,

placing said shoulder pad on said safety seatbelt by engaging said seatbelt in said split than fully sliding it on,

closing said split by locking said two projections into each other.

In drawings which illustrate some of the embodiments of this invention:

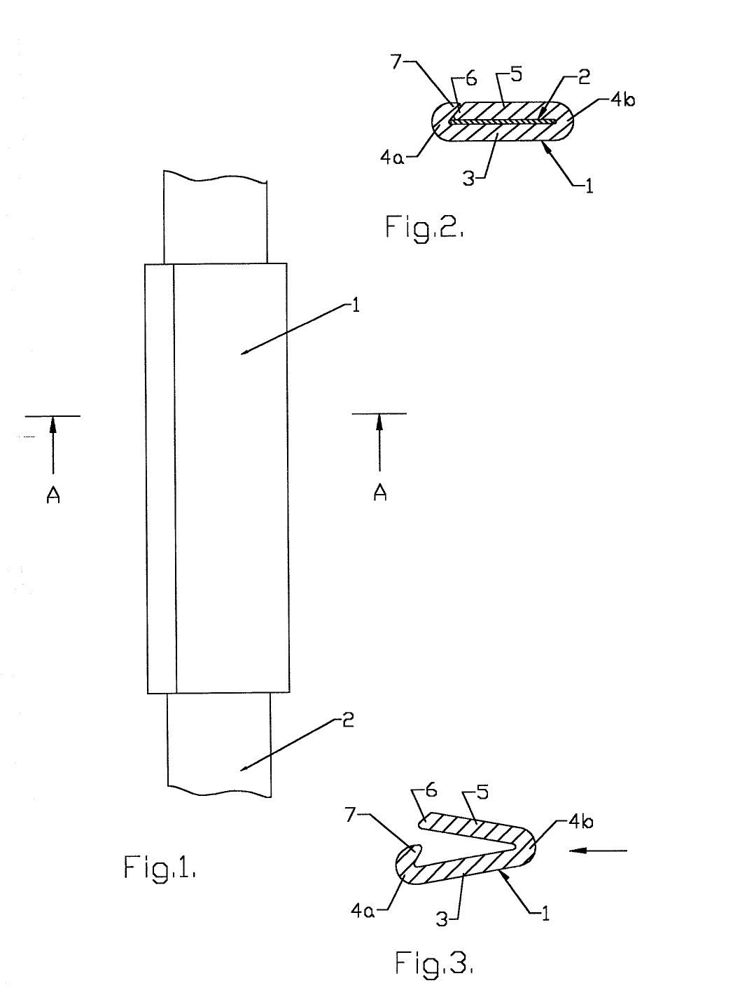

FIG. 1 shows the top plan view of the shoulder pad of this invention placed on a seatbelt,

FIG. 2 shows the sectional view of FIG. 1 along line A-A, and

FIG. 3 shows the sectional view of the shoulder pad of this invention being in free state.

FIG. 1 shows the top view of a shoulder pad 1 being placed on a safety seatbelt 2 covering it over a predetermined length. The shoulder pad 1 has a bottom wall 3, a first side wall 4a, a second side wall 4b, and a top wall 5 as shown in FIG. 2. The bottom wall 3 covers one of the flat sides of the safety seatbelt 2. Joining to one end of the bottom wall 3 the first side wall 4a is protruding upward and extending over the thickness of the safety seatbelt 2. Joining to the other end of bottom wall 3 the second side wall 4b is protruding upward and also extending over the thickness of the seatbelt 2. The upper wall 5 is joined to the second side wall 4b, and it is mated to cover the other flat side of safety seatbelt 2.

The first side wall 4a has a projection 7 protruding over bottom wall 3. The top wall 5 also has a projection 6 at its end mated to engage projection 7. In this installed position of shoulder pad 1, projection 7 is engaging projection 6, whereby the walls 3, 4a, 4b, and 5 are enclosing the seatbelt 2.

The walls 3, 4a, 4b, and 5 of shoulder pad 1 are flexible and resiliently squeezeable by a light force to provide a soft feel when touched by a user. Low cost materials such as a wide variety of foamed plastics are available to meet the above requirements. FIG. 3 shows the cross section of shoulder pad 1 in a free state. Shoulder pad 1 is a one-piece constructed design made of a molded or extruded foamed plastic such as polyethylene.

Installing the shoulder pad 1 on a seatbelt requires only the sliding of shoulder pad 1 over the seatbelt from the side in the direction of the arrow as shown in FIG. 3., and than the pressing of bottom wall 3 and top wall 5 toward each other until projections 6 and 7 are engaged. The removal of shoulder pad 1 from a seatbelt requires the disengagement of projections 6 and 7, then the pulling of shoulder pad 1 to the side. Since the walls 3, 4a, 4b, and 5 are resilient, the disengagement of projections 6 and 7 can be achieved by bending bottom wall 3 by slightly pressing side-walls 4a and 4b downward.

Both the installation and the removal of shoulder pad 1 are simple and easy, thereby can be done quickly if desired.

It is noted that although the thicknesses of walls 3, 4a, 4b, and 5 can be made to various sizes, they should be kept relatively small to avoid interference with the action of the safety seatbelt. Thicknesses up to about ¾ of an inch have negligible effect on the safety action of the seatbelt.

1. A shoulder pad to prevent a predetermined length of a safety seatbelt to come into direct contact with its user, said shoulder pad has a bottom wall mated to cover one of the flat sides of said safety seatbelt, a first side wall joined to and protruding upward from said bottom wall at one end, a second side wall joined to and protruding upward from said bottom wall at its other end, and a top wall joined to said second side wall and extending toward said first side wall and diverging upward to provide an opening above said first side wall, said opening is larger than the thickness of said seatbelt, said first side wall has a first projection above and over the bottom wall, said top wall has a second projection at its end mated to said first projection, wherein a light pressure of bottom wall and top wall toward each other causes said opening to close and said first projection and said second projection to lock into each other.

2. As in claim 1, when said shoulder pad is made of one-piece and of a molded or extruded foamed plastic material which is flexible and resiliently sqeezeable.

3. This invention further provides a method to install a shoulder pad on a safety seatbelt, comprising:
providing a shoulder pad of the desired length and made of a softer material than that of said safety seatbelt, said shoulder pad has flexible and resilient walls mated to wrap around said seatbelt, said shoulder pad is split along its length and has a slightly opened V-shape in cross section when being in free state, said split is wider than the thickness of said seatbelt, said shoulder pad also has two projections mated to lock into each other, one projection is placed along one side of said split, the other projection is placed along the opposite side of said split,
placing said shoulder pad on said safety seatbelt by engaging said seatbelt in said split than fully sliding it on,
closing said split by locking said two projections into each other.
